(19) United States
(12) Patent Application Publication
(10) Pub. No.: US 2005/0248157 A1
(43) Pub. Date: Nov. 10, 2005

(54) Rehabilitating pipe and a laying method thereof

(75) Inventors: Koji Kaneta, Hiratsuka-shi (JP); Kenji Fujii, Hiratsuka-shi (JP); Takeshi Hasegawa, Hiratsuka-shi (JP)

Correspondence Address: BRUCE L. ADAMS, ESQ., 31ST FLOOR, 50 BROADWAY, NEW YORK, NY, 10004, US

(73) Assignee: Shonan Gosei-Jushi Seisakusho K.K.

(21) Appl. No.: 11/071,716

(22) Filed: Mar. 3, 2005

(30) Foreign Application Priority Data
Apr. 21, 2004 (JP) 2004-124915

(51) Int. Cl. F16L 35/00

(52) U.S. Cl. 285/406

(57) ABSTRACT

A rehabilitating pipe is laid inside an existing pipe using segments each having coupling surfaces in the circumferential direction and the longitudinal direction of the existing pipe. The coupling surfaces in the circumferential or longitudinal direction are mutually bonded substantially across their entire surfaces via an adhesive or a sheet impregnated with an adhesive and mechanically joined to couple the segments and assemble the rehabilitating pipe. Such an arrangement makes it possible to improve the joining strength, uniformity and watertightness in the coupling portion of the segments.

### BACKGROUND OF THE INVENTION

1. Field of the Invention

The present invention relates to a rehabilitating pipe laid inside an existing pipe, such as a sewer pipe, for rehabilitating the existing pipe, and a laying method thereof.

2. Description of the Prior Art

A method of rehabilitating an existing pipe is known from Japanese Laid Open Patent Publication No. 2003-286742, and the like, wherein, to rehabilitate an existing pipe such as a sewer pipe, the assembly worker assembles and lays inside the existing pipe a rehabilitating pipe whose outer diameter is slightly less than the inner diameter of the existing pipe, fills and hardens a filler (not shown) in a gap between the outer periphery of this rehabilitating pipe and the inner wall surface of the existing pipe, thereby constructing a compound pipe. The rehabilitating pipe is assembled by coupling segments in the circumferential direction and the longitudinal direction of the existing pipe. Conventionally, the segments are mutually coupled by tightening bolts and nuts at a plurality of locations in both the circumferential direction and the longitudinal direction.

Furthermore, a structure is adopted that ensures the watertightness of the coupling portion by forming a protruding part in one of the coupling surfaces and a recessed part in the other coupling surface of the segment in the circumferential direction; forming a protruding part also in one of the coupling surfaces and a recessed part in the other coupling surface in the longitudinal direction; coating the recessed part with a sealing material having water resistance and chemical resistance; and then interfitting the protruding part to the recessed part.

Although the joining strength is high in the conventional structure, at each of the plurality of mechanically coupled portions where the bolt and nut are tightened in the circumferential and longitudinal directions, there is a problem in that the joining strength is low at the other portions, thus creating an unfortunate variation in the joining strength that impacts the mechanical strength of the entire rehabilitating pipe.

In addition, in the conventional structure, the recessed part that extends along the longitudinal direction at the circumferential coupling surface of the segment and the recessed part that extends along the circumferential direction at the longitudinal coupling surface thereof are coated with a sealing material, and that sealing is performed respectively in a line and not across the entire surface of the coupling surface in both the directions; therefore, the watertightness at the coupling portion can not be said to be perfectly ensured.

### SUMMARY OF THE INVENTION

It is therefore an object of the invention to provide a rehabilitating pipe and a laying method thereof, wherein the joining strength of the coupling portion of mutually coupled segments in the circumferential direction or the longitudinal direction is improved and made more uniform, and the watertightness at the coupling portion is improved.

A rehabilitating pipe according to the invention is laid by coupling segments in the circumferential direction and the longitudinal direction of an existing pipe for rehabilitation thereof. The segment is provided with coupling surfaces in the circumferential and longitudinal directions. The coupling surfaces in the circumferential or longitudinal direction are mutually bonded substantially across their entire surfaces and mechanically joined to couple the segments for assembly of the rehabilitating pipe.

The segment is also provided with an interfitting part on the coupling surfaces and the coupling surfaces are mutually bonded substantially across their entire surfaces including the surfaces of the interfitting part.

The coupling surfaces of the segment are bonded substantially across their entire surfaces via an adhesive or a sheet impregnated with an adhesive.

The invention further provides a method for laying a rehabilitating pipe inside an existing pipe by coupling segments each having coupling surfaces in the circumferential direction and the longitudinal direction of the existing pipe. The method comprises the steps of preparing a sheet impregnated with an adhesive; affixing said sheet substantially across the entire surface on said coupling surface in the circumferential or longitudinal direction; and mechanically coupling the segments via the sheet to assemble the rehabilitating pipe.

According to the invention, an adhesive can be used instead of the sheet impregnated with the adhesive. In this case, the adhesive is applied substantially across the entire surface on said coupling surface in the circumferential or longitudinal direction, and the coupling surfaces are bonded with the adhesive. The segments are then mechanically coupled to assemble the rehabilitating pipe.

According to the present invention, the mutually coupled surfaces in the circumferential direction and/or in the longitudinal direction of all segments are substantially bonded across their entire surfaces thereof. This remarkably improves the joining strength of the coupling portion of mutual segments in the circumferential direction and/or the longitudinal direction, thereby making the joining strength uniform and improving the mechanical strength of the rehabilitating pipe. Furthermore, the bonding of the coupling surfaces of the segments across their entire surfaces provides a superior advantage in that the watertightness at the coupling portion can be markedly improved.

Further features of the invention, its nature and various advantages will be more apparent from the accompanying drawings and following detailed description of the invention.

### BRIEF DESCRIPTION OF THE DRAWINGS

FIG. 1 is partially broken perspective view showing a segment for a rehabilitating pipe in an embodiment of the present invention.

FIG. 2 is a perspective view illustrating how an adhesive sheet is affixed to the segment.

FIG. 3 is a perspective view illustrating a process wherein the segments are coupled in the circumferential direction and in the longitudinal direction.

FIG. 4 is a longitudinal cross sectional view taken along the circumferential direction of the coupling portion that depicts a state wherein the segments are mutually coupled in the circumferential direction.

FIG. 5 is a radial cross sectional view taken along the longitudinal direction that depicts a state wherein the segments are mutually coupled by coupling members in the longitudinal direction.

FIG. 6 is a partially broken perspective view showing a rehabilitating pipe assembled inside the existing pipe using segments.

### DESCRIPTION OF THE PREFERRED EMBODIMENTS

The present invention will be described based on preferred embodiments, referring to the attached drawings.

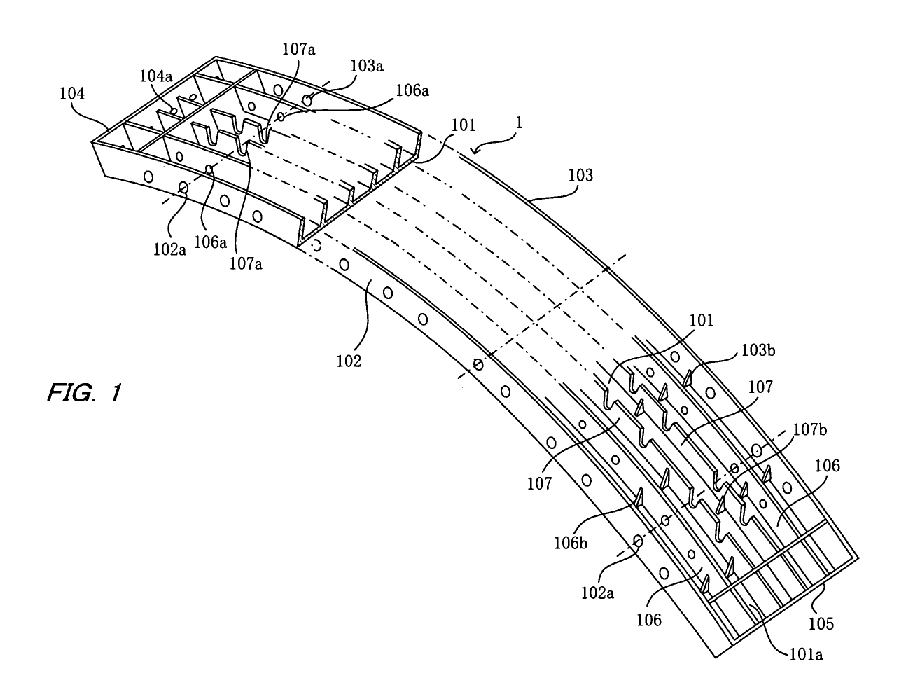

A rehabilitating pipe according to the present invention is assembled by coupling segments in both the circumferential direction and the longitudinal direction of an existing pipe. The rehabilitating pipe has an outer diameter that is a prescribed amount less than the inner diameter of the existing pipe and is assembled using the segments. A segment 1 is formed as a block comprising an inner plate 101, side plates 102 and 103, end plates 104 and 105, and two each of reinforcing plates 106 and 107, as shown in FIG. 1. These plates 101 through 107 are integrally molded with a transparent plastic to provide an integral segment.

The inner plate 101 is formed as a plate having a prescribed width and is arcuately curved at a prescribed angle that divides the circumference into a plurality of equal parts, e.g., 72° for division into five parts, and the bottom thereof forms the inner circumferential surface of the rehabilitating pipe, and the latitudinal direction of the arc is the longitudinal direction of the rehabilitating pipe. A plurality of rectangular openings 101a is formed respectively on both end parts of the inner plate 101 for performing from the inside the work for mutually coupling the segments 1 in the circumferential direction.

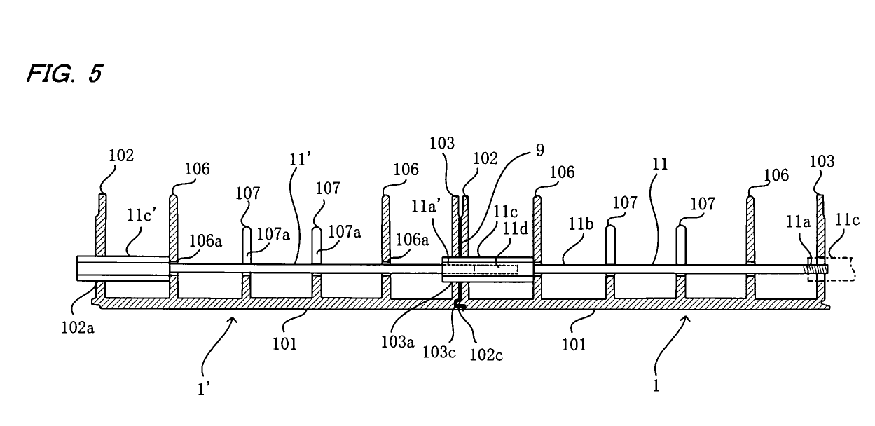

The side plates 102 and 103 are formed at both side edges across the entire length along the circumferential direction of the inner plate 101, and are provided upright at a prescribed height on the inner plate 101. A plurality of through holes 102a and 103a (herein, 14) is formed in each of the side plates 102 and 103 at a prescribed interval in the circumferential direction for passing therethrough coupling members in the longitudinal direction. In addition, although not shown in FIG. 1, a protruding part (protruding line) 102c and a recessed part (recessed line) 103c, having shapes that substantially conform to one another, are formed at the lower end part of the outer surface of each of the side plates 102 and 103 along the side edge of the inner plate 101 across the entire lengths thereof, as shown in FIG. 5.

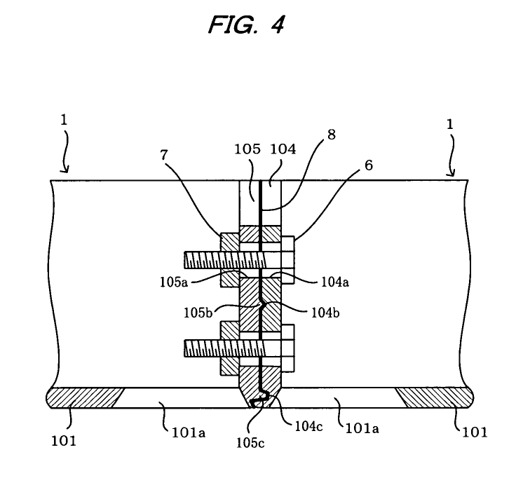

The end plates 104 and 105 are formed at both end edges of the inner plate 101 across the entire length thereof, and are provided upright on the inner plate 101 at a height the same as the side plates 102 and 103. Through holes 104a and 105a are formed at a plurality of locations in the end plates 104 and 105 for passing therethrough bolts that mutually couple the segments 1 in the circumferential direction (refer also to FIG. 4). In addition, although not shown in FIG. 1, recessed parts (recessed lines) 104b and 104c and protruding parts (protruding lines) 105b and 105c, having shapes that substantially conform to one another, are formed at the middle part and the lower end part of each outer surface of each of the end plates 104 and 105. These parts 104b, 104c, 105b and 105c extend along the latitudinal direction of the end plates 104 and 105 (longitudinal direction) across the entire width thereof.

The reinforcing plates 106 and 107 reinforce the mechanical strength of the entire segment 1, and are provided upright at a prescribed height on the inner plate 101 and on the inner sides of the side plates 102 and 103. In the reinforcing plates 106 and 107 are formed a plurality of through holes 106a and notched parts 107a for inserting therethrough the coupling members in the longitudinal direction at a position corresponding respectively to the through holes 102a and 103a of the side plates 102 and 103. In addition, laterally protruding small right triangular protruding plates 103b, 106b, and 107b (the protruding plate of the side plate 102 is not shown) are formed at a plurality of locations on the inner surfaces of the side plates 102 and 103 and both side surfaces of the reinforcing plates 106 and 107 to prevent deformation thereof. This forms a rib structure that enhances the strength of the segment 1.

When the existing pipe to be repaired is circular in cross sectional shape, the segment 1 corresponds to one block obtained when a circular pipe with corresponding outside and inside diameters is cut off in slices at a prescribed width and the thus sliced pipe is divided for segmentation in the circumferential direction into parts (preferably into equal parts).

The number of reinforcing plates or the number of protruding plates can be varied in accordance with the required strength of the segment; if strong, then some or all can be omitted. In addition, because the segment functions as an optional rehabilitating member or repairing member, it is not limited to an arcuate type or fan type as shown in FIG. 1, and can be made a parallelepiped, in accordance with the cross sectional shape or size of the existing pipe or the repair location of the existing pipe, and can also be made a shape bent into a rounded right angle.

The segments are successively coupled in the circumferential direction with the outer surfaces of every end plate of each segment mutually aligned and also the inner surfaces of every inner plate thereof mutually aligned. The segments are also successively coupled in the longitudinal direction so that the outer surfaces of every side plate of each segment are mutually aligned and the inner surfaces of each inner plate are mutually aligned. Such processes allow a rehabilitating pipe to be assembled with the inner entire surface thereof being uniform without any gap between the segments.

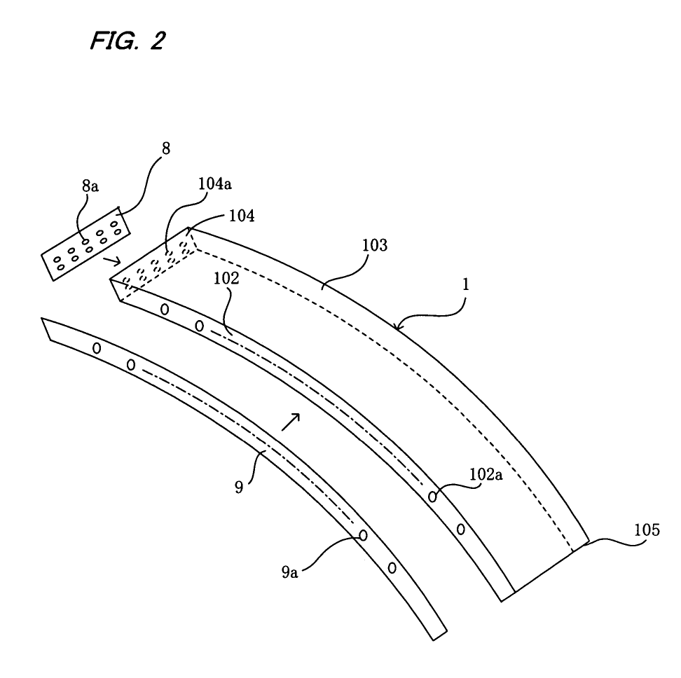

In the present embodiment adhesive sheets 8 and 9 as shown in FIG. 2 are used to mutually bond the coupling surfaces in the circumferential and longitudinal directions of segments 1 for improvement in the joining strength at the coupling portions.

The adhesive sheets 8 and 9 are sheets each comprising, for example, glass fibers or carbon fibers impregnated with an adhesive with a plastic film affixed to the entire front surface and the entire rear surface thereof. As the adhesive, it is preferable to use a radical polymer type thermosetting resin, such as an unsaturated polyester resin, or an epoxy (meta) acrylate resin, and an ultraviolet light setting adhesive comprising a photopolymerization initiator, such as a benzoic derivative or a benzyl ketal type. The use of such adhesives is because the assembly worker can set the adhesive at a desired time. With self-setting adhesives that set with the passage of time, the assembly work unfortunately is constrained by the setting time. With a thermosetting adhesive, heating inside the existing pipe is problematic. However, it will be understood that the present invention is not limited to an ultraviolet light setting adhesive.

The adhesive sheet 8 is rectangularly formed corresponding to the outer surfaces of the end plates 104 and 105, and holes 8a are formed at a plurality of locations corresponding to the through holes 104a and 105a for inserting therethrough bolts for coupling in the circumferential direction. Further, the plastic film (not shown) on the rear surface side of the adhesive sheet 8 can be peeled off so that the adhesive sheet 8 can be affixed to the outer surface of the end plate 104 or the outer surface of the end plate 105, as shown by the arrow. As shown in FIG. 4, the shape and dimensions of the adhesive sheet 8 are set so that the adhesive sheet 8 covers the entire surface of each of the outer surfaces that includes the surfaces of the recessed parts 104b and 104c of the end plate 104, and the entire surface of each of the outer surfaces that includes the surfaces of the protruding parts 105b and 105c of the end plate 105.

The adhesive sheet 9 is arcuately strip-shaped corresponding to the outer surfaces of the side plates 102 and 103, and holes 9a are formed at a plurality of locations corresponding to the through holes 102a and 103a for inserting coupling members therethrough. The plastic film on the rear surface side of the adhesive sheet 9 can be peeled off, and the adhesive sheet 9 can be affixed to the outer surfaces of the side plates 102 or 103. As shown in FIG. 5, the shape and dimensions of the adhesive sheet 9 are set so that the adhesive sheet 9 can cover substantially the entire surface (excluding the recessed upper end part) of each of the outer surfaces that includes the surface of a protruding part 102c of the side plate 102, or substantially the entire surface of each of the outer surfaces that includes the surface of a recessed part 103c of the side plate 103.

The following explains the details of a laying method that, inside an existing pipe, assembles and lays a rehabilitating pipe with the segments 1.

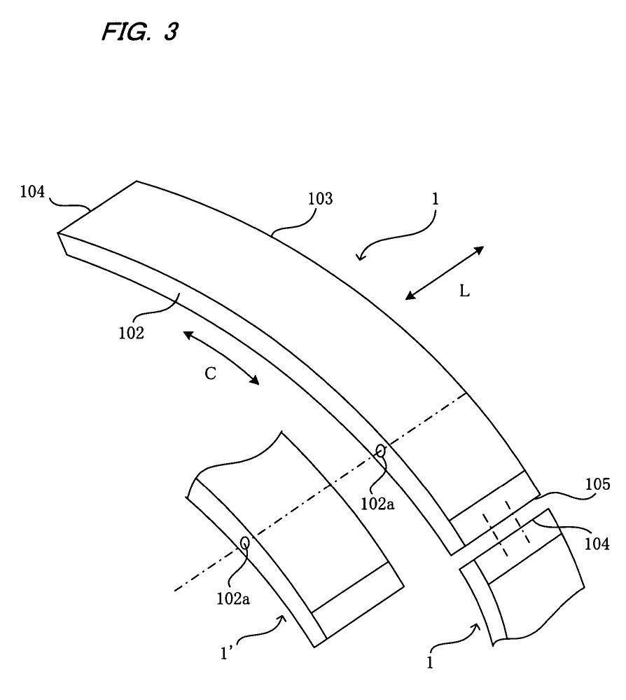

First, the segments 1 are carried into the existing pipe and successively coupled in the circumferential direction, as shown in FIG. 3. However, prior to this coupling, the plastic film is peeled off of the rear surface side of the adhesive sheet 8 in FIG. 2, and the adhesive sheet 8 is affixed to the outer surface of the end plate 104 or 105 of one of the segments 1, and the plastic film on the front surface side thereof is peeled off immediately before coupling.

Coupling in the circumferential direction is performed, as shown in detail in FIG. 4, by interfitting the recessed parts 104b and 104c and the protruding parts 105b and 105c of each segment 1 via the adhesive sheet 8; positioning each segment 1 so that the inner surfaces of all the inner plates 101 form the same surface, the outer surfaces of all the side plates 102 form the same surface, and the outer surfaces of all the side plates 103 form the same surface; mutually tightly sealing the outer surfaces of the end plates 104 and 105 of all the segments 1; inserting bolts 6 through the through holes 104a, 105a and the holes 8a (shown in FIG. 2) from the openings 101a of the inner plates 101; screwing on nuts 7 for mechanical coupling; and tightening both end plates 104, 105. Furthermore, after the coupling is completed, each opening 101a is tightly sealed by a cover (not shown) and the like.

After the segments are coupled into a ring shape or after a prescribed number of segments are coupled in the circumferential direction C, another segment 1′ is coupled in the longitudinal direction L to the segment already coupled in the circumferential direction, as shown in FIG. 3.

However, before this coupling, the plastic film on the rear side of the adhesive sheet 9 in FIG. 2 is peeled off, and the adhesive sheet 9 is affixed to the outer surface of one of the side plates 102 or 103 of the segments 1 and 1′, and the plastic film on the front surface side thereof is peeled off immediately before coupling.

The coupling in the longitudinal direction is performed, as shown in FIG. 5, by using a rod shaped coupling member 11 made of metal and that integrally joins a rod 11b with one end thereof formed as a screw part 11a, and the other end as a nut part 11c. A screw hole 11d is formed in the nut part 11c to receive the screw part 11a of the rod of another coupling member.

In FIG. 5, the coupling member 11 on the right side is already joined to the nut part 11c of another coupling member, shown by the chain line, and fixed to the segment 1. To couple another segment 1′ to this segment 1, both segments 1 and 1′ are first positioned so that the inner surfaces of the inner plates 101 thereof align and form a uniform surface. The outer surfaces of the side plates 102 and 103 of both the segments are then brought into tightly contact with each other via the adhesive sheet 9 with the nut part 11c protruding from the side plate 102 of the segment 1 interfitted with a through hole 103a of the side plate 103 of the segment 1′ and with the protruding part 102c of the segment 1 interfitted with the recessed part 103c of the segment 1′.

A coupling member 11′ is then inserted through from the through hole 102a of the side plate 102 of the segment 1′, and the screw part 11a′ thereof is screwed into the screw hole 11d of the nut part 11c of the coupling member 11. At this time, the screw part 11a′ and a rod 11b′ are inserted from the through hole 102a through the through hole 106a, two notched parts 107a, and the through hole 106a, and screwed in.

When the screw part 11a′ is screwed into the screw hole 11d until a nut part 11c′ of the coupling member 11′ hits against the reinforcing plate 106 of the segment 1′, the coupling member 11′ clamps the segment 1′ against the segment 1 to thereby couple both segments 1 and 1′ mechanically. Because the coupling of every segment is performed using, for example, four coupling members per segment, both segments 1 and 1′ are coupled rigidly in the longitudinal direction.

When the segment 1 in FIG. 5 is the initial segment in the longitudinal direction, the coupling member as shown in FIG. 5 cannot be used, and therefore a fixing member having a structure the same as the nut part 1c that can fix the segment 1 is used as the coupling member.

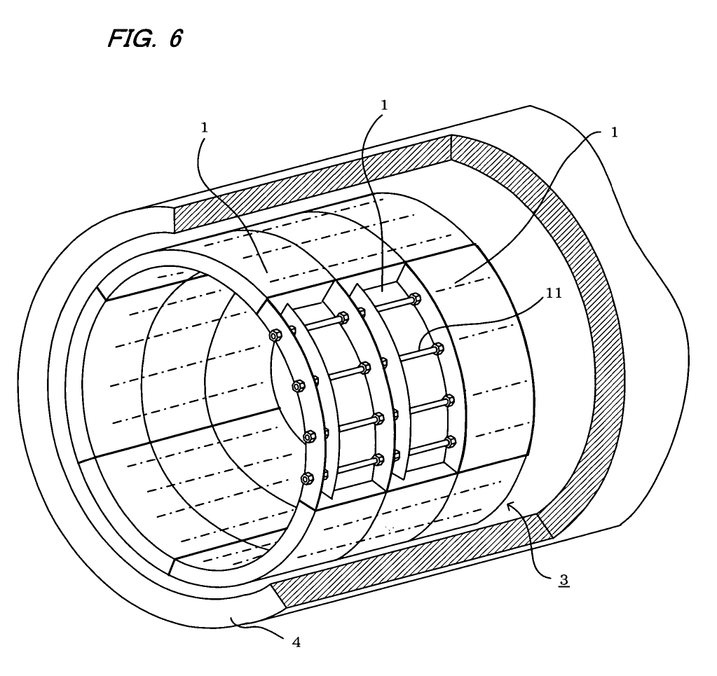

A rehabilitating pipe 3 as shown in FIG. 6 can thus be laid by successively coupling the segments 1 inside an existing pipe 4 in the circumferential direction and the longitudinal direction.

If an ultraviolet light setting adhesive is used for the adhesive sheets 8 and 9, then the outer surfaces of the end plates 104 and 105 and the outer surfaces of the side plates 102 and 103 of all coupled segments 1 are mutually bonded by irradiating the adhesive sheets 8 and 9 with ultraviolet light at a convenient time in accordance with the circumstances of the assembly work, e.g., every time coupling is performed in the longitudinal direction to a certain length, or after completion of all coupling. On the other hand, if a self-setting type adhesive is used, then it is understood that bonding is performed by the natural setting of the adhesive with the passage of time.

After the laying of the rehabilitating pipe 3 is completed as described above, the gap between the existing pipe 4 and all of the segments 1 is filled with grout (not shown), which is hardened to integrate with the existing pipe 4 into a compound pipe. The coupled segments 1 are schematically depicted in FIG. 6 as a simple block shape, and only one reinforcing plate is shown for the segments 1. In FIG. 6 the coupling members 11 are also illustrated with some of them depicted by dashed lines. Furthermore, although all of the segments 1 in FIG. 6 are coupled with their end plates aligned in the longitudinal direction, they can also be coupled with their end plate positions offset. In addition, it is understood that the number of coupling members 11 inserted per segment 1 is not limited to four.

In the above embodiment, the segments are successively coupled at only one side of the existing pipe in the longitudinal direction (single sided coupling), but it is also possible to successively couple the segments at both sides in the longitudinal direction (bilateral coupling). In this case, the pipe laying time can be reduced because the segments can be coupled from both sides.

As described above, the coupling surfaces (the outer surfaces of the end plates 104 and 105) of the segments 1 are mutually joined in the circumferential direction by the tightening of the bolts 6 and the nuts 7 and further bonded across the entire surface via the adhesive sheet 8, and the coupling surfaces (the outer surfaces of the side plates 102 and 103) are also mutually joined in the longitudinal direction by the tightening of the coupling members 11 and further bonded substantially across the entire surface via the adhesive sheet 9. This improves the joining strength of the coupled portion of the mutual segments 1 and prevents variation in the joining strength in the circumferential direction as well as in the longitudinal direction, thus making the joining strength uniform and improving the mechanical strength of the rehabilitating pipe.

In addition, the coupling portion in the circumferential direction of mutual segments 1 is sealed by the adhesive sheet 8 across the entire surface of the coupling surfaces, including the interfitting portion of the recessed parts 104b and 104c and the protruding parts 105b and 105c, and the coupling portion in the longitudinal direction is also sealed by the adhesive sheet 9 substantially across the entire surface of the coupling surfaces including the interfitting portion of the protruding part 102c and the recessed part 103c. This provides a remarkable improvement in watertightness at the coupling portion.

In the above-mentioned embodiment, the coupling surfaces of all the segments 1 to be coupled in the circumferential direction as well as in the longitudinal direction are mutually bonded by the adhesive sheets 8 and 9; however, it is also acceptable to bond them just with an adhesive. In this case, before mutually coupling the segments 1 in the circumferential direction (preferably immediately before), the adhesive is applied over the entire surface of the outer surfaces of the end plates 104 or 105 of one or both of the segments 1 (including the surfaces of the recessed parts 104b and 104c and the protruding parts 105b and 105c), the outer surfaces of the end plates 104 and 105 of the segments 1 are mutually tightly sealed and bonded with this adhesive, and the segments 1 are mutually mechanically coupled by the tightening of the bolts 6 and the nuts 7.

Similarly, before mutually coupling the segments 1 in the longitudinal direction, the adhesive is applied to substantially the entire surface of each of the outer surfaces of the side plates 102 or 103 of one or both of the segments 1 (including the surfaces of the protruding part 102c and the recessed part 103c), the outer surfaces of the side plates 102 and 103 of segments 1 are mutually tightly sealed and bonded via this adhesive, and the segments 1 are mutually mechanically coupled by the tightening of the coupling members 11.

Furthermore, while it is acceptable to use an ultraviolet light setting type for the adhesive used herein, it is also acceptable to use a 1-component or 2-component self-curing type. In the case of two components, it is understood that a means is needed to perform the coating while mixing the resin and the setting agent of the adhesive.

In the embodiment in which the adhesive is used instead of the adhesive sheet, the rehabilitating pipe assembly work is worse in efficiency compared with the first mentioned embodiment in which the adhesive sheet is used. However, just the adhesive should be prepared and the adhesive sheets 8 and 9 are not needed. This provides an advantage of reduced cost with the same effects of the joining strength and the watertightness as in the first embodiment.

Furthermore, in the embodiments explained above, the coupling surfaces of all the segments 1 are mutually bonded both in the circumferential and longitudinal directions; however, depending on the shape of the rehabilitating pipe and the segments, and the circumstances of the assembly work, just the coupling surfaces in the circumferential direction, or coupling surfaces in the longitudinal direction are mutually bonded.

1. A rehabilitating pipe laid by coupling segments in the circumferential direction and the longitudinal direction of an existing pipe for rehabilitation thereof, wherein the segment is provided with coupling surfaces in the circumferential and longitudinal directions, said coupling surfaces in the circumferential or longitudinal direction being mutually bonded substantially across their entire surfaces and mechanically joined to couple the segments for assembly of the rehabilitating pipe.

2. A rehabilitating pipe according to claim 1, wherein said segment is provided with an interfitting part on said coupling surfaces and said coupling surfaces are mutually bonded substantially across their entire surfaces including the surfaces of said interfitting part.

3. A rehabilitating pipe according to claim 1, wherein said coupling surfaces are bonded substantially across their entire surfaces via a sheet impregnated with an adhesive.

4. A rehabilitating pipe according to claim 3, wherein a coupling means is inserted through said coupling surfaces to mechanically couple said segments in the circumferential or longitudinal direction, and a hole is formed in said sheet to pass the coupling means therethrough.

5. A rehabilitating pipe according to claim 3, wherein the adhesive impregnated in said sheet is an ultraviolet light setting adhesive.

6. A rehabilitating pipe according to claim 1, wherein said coupling surfaces are bonded substantially across their entire surfaces via an adhesive.

7. A method for laying a rehabilitating pipe inside an existing pipe by coupling segments each having coupling surfaces in the circumferential direction and the longitudinal direction of the existing pipe, comprising the steps of:
preparing a sheet impregnated with an adhesive;
affixing said sheet substantially across the entire surface on said coupling surface in the circumferential or longitudinal direction; and
mechanically coupling the segments via the sheet to assemble the rehabilitating pipe.

8. A method for laying a rehabilitating pipe inside an existing pipe by coupling segments each having coupling surfaces in the circumferential direction and the longitudinal direction of the existing pipe, comprising the steps of:
preparing an adhesive;
applying the adhesive substantially across the entire surface on said coupling surface in the circumferential or longitudinal direction;
bonding the coupling surfaces with the adhesive and
mechanically coupling the segments to assemble the rehabilitating pipe.
